(19) United States
(12) Patent Application Publication
(10) Pub. No.: US 2014/0229738 A1
(43) Pub. Date: Aug. 14, 2014

(54) TIMESTAMPING SYSTEM AND TIMESTAMPING PROGRAM

(71) Applicant: Atsushi Sato, Tokyo (JP)

(72) Inventor: Atsushi Sato, Tokyo (JP)

(73) Assignee: NOMURA RESEARCH INSTITUTE, LTD., Tokyo (JP)

(21) Appl. No.: 13/635,046

(22) PCT Filed: Nov. 1, 2011
(86) PCT No.: PCT/JP11/75209

§ 371 Date: Sep. 14, 2012

(51) Int. Cl. H04L 9/32; H04L 29/06

(52) U.S. Cl. CPC H04L 9/3297; H04L 63/068
USPC 713/178

(57) ABSTRACT

A timestamping system including a plurality of time servers and a timestamping device, the timestamping device including a dividing processing unit dividing an electronic document into a plurality of divided data items by a secret sharing scheme, a distributing processing unit transmitting the divided data items to different servers, respectively, and collecting, from each of the servers, each of the divided data items corresponding to the electronic document being requested for timestamping by a user, a restoring processing unit restoring the electronic document by a secret sharing scheme based on each of the collected divided data items, and an existed time calculating unit calculating and outputting an existed time regarding the electronic document based on timestamps applied to the data items when the electronic document can be normally restored.

### TECHNICAL FIELD

The present invention relates to technology of timestamping, more particularly, technology effectively applied to a timestamping system and timestamping program for authenticating clock time or a period of time at/in which a file or data is created and stored.

### BACKGROUND

As information technology has been widely used in business dealings and official documents, the frequency of exchanges of electronic documents via the network has been increasing. As to such electronic documents, electronic signature is widely used as a mechanism to detect and prevent forgery and falsification. According to this mechanism, it is possible to authenticate a creator of an electronic document. However, only an electronic signature cannot authenticate a created time of the electronic document.

Normally, when an electronic document is created and saved on an information processing device, a timestamp is applied by the information processing device. However, a system time of the information processing device is not always precise and it can be easily changed by a command etc. Compared to this, as a mechanism for authenticating created time of an electronic document (or a time at which at least the electronic document existed), timestamping (time authentication) is used.

According to a general timestamping mechanism, for example, a hash of an electronic document that requires authentication of time is acquired and the hash is transmitted to a timestamping provider. When the authentication provider receives the hash of the electronic document, another hash is created from data of a combination of the hash and precise time information using an atomic clock or else. Information of the hash which is encrypted by a private key is transmitted to a user as timestamp information. As well as authenticating that the timestamp is created by the timestamping provider since the timestamp information can be decoded by a public key of the timestamping provider, it is possible to detect forgery and falsification of the electronic document and time by calculating the hash of the electronic document and time by the authentication provider itself and comparing the same with a hash included in the timestamp.

As technique related to this, for example, Japanese Patent Application Laid-Open Publication No. 2003-244139 describes a timestamp sealing system capable of easily authenticating date and time of creating a document and easily and surely verifying the date and time. More specifically, a document creating terminal device transmits a created document and a timestamp request message to a timestamp issuing server, the timestamp issuing server replies after adding an electronic signature to the document with a private key. A terminal device transmits a document file with a timestamp received from the document creating terminal device and a timestamp verification request message to a timestamp verification server. The timestamp verification server verifies with a signature verifying private key and replies with a verification result. The document creating terminal device verifies the signature and the terminal device verifies the verification result of the signature with a signature public key, respectively.

In addition, for example, Japanese Patent Application Laid-Open Publication No. 2006-303963 describes a timestamping system which makes more difficult to make a falsification etc. of time information and effectively creates signature data that authenticates time at which information existed based on and adds the signature data to the information based on an observation result of natural phenomena etc. varying in real time according to time instead of time information according to an atomic clock etc. More specifically, the timestamping system includes: a identity authenticating data acquiring unit which acquires data for authenticating identity created based on information for verifying identity of information; timestamping data creating unit which observes an object that changes with time in response to instructions from a user and creates timestamping data based on observation data obtained as a result of the observation; a signature data creating unit which creates signature data indicating that information existed at the time at which the object was observed based on a set of the identity authenticating data and the time authenticating data; and an information recording unit which records the authentication data with corresponding the authentication data to the information.

### DISCLOSURE OF THE INVENTION

As to a mechanism of existing technology, for creating time information to be authenticated, a special mechanism for which operation load and cost are high is required; for example, a mechanism for time information creation using an atomic clock, a mechanism observing and recording natural phenomena etc. changing in real time over time, etc.

However, depending on a type of an electronic document and data to be an authenticated object, there is often a case of not requiring much accuracy of time to be required upon timestamping and thus there is a need for constructing a mechanism of timestamping which can verify time at which at least the electronic document existed at an accuracy to some extent at a relatively low cost and in a simple manner.

Consequently, a preferred aim of the present invention is to provide a timestamping system and timestamping program which can be constructed at a low cost and in a simple manner without requiring a special mechanism for creating time information. The above and other preferred aims and novel characteristics of the present invention will be apparent from the description of the present specification and the accompanying drawings.

### SUMMARY

The typical ones of the inventions disclosed in the present application will be briefly described as follows.

A timestamping system according to a typical embodiment of the present invention is a timestamping system including: a plurality of servers having a recording device; and a timestamping device which is connected to each of the servers via a network and verifies an existing time at which at least an electronic document was created and existed, the timestamping system having the following features.

More specifically, the timestamping device includes: a division processing unit which divides the electronic document into a plurality of divided data items by a secret sharing scheme; a sharing processing unit which transmits the divided data items to different ones of the servers, respectively, and collects each of the divided data items corresponding to the electronic document about which timestamping is requested by a user; a restoring processing unit which restores the electronic document by the secret sharing scheme based on each of the divided data items collected from each of the servers; and an existed time calculating unit which calculates and outputs the existed time regarding the electronic document based on a timestamp added to each of the divided data items collected from each of the servers when the electronic documents can be normally restored in the restoring processing unit. In addition, the server stores the divided data transmitted from the timestamping system after adding the timestamp to the divided data.

Also, the present invention can be also used to timestamping program which makes a computer function as a timestamping device in such a timestamping system as described above.

The effects obtained by typical aspects of the present invention will be briefly described below.

According to the typical embodiment of the present invention, it is possible to construct a timestamping system capable of proving, at a certain level of accuracy, an occurrence time of a phenomenon such as occurrence of a specific processing or an event at a low cost and in a simple manner without requiring a special mechanism for creating time information.

### BRIEF DESCRIPTIONS OF THE DRAWINGS

FIG. 1 is a diagram schematically illustrating a configuration example of a timestamping system which is an embodiment of the present invention;

FIG. 2 is a diagram schematically illustrating an example of proving an existed time of original data according to the embodiment of the present invention; and

FIG. 3 is a diagram schematically illustrating an example of a processing upon storing an electronic document and performing timestamping.

### DETAILED DESCRIPTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

A timestamping system which is an embodiment of the present invention divides a file or data that will possibly be necessary to be subjected to timestamping such as an electronic document into a plurality of divided data items by what they call secret sharing scheme and distributes and stores each of the divided data items to different servers or data centers. When timestamping of the electronic document becomes necessary, the divided data items corresponding to the electronic document are collected from respective servers and the electronic document is restored by the secret sharing scheme. Here, timestamping, which indicates that the electronic document existed at a certain time, is performed based on a successive restoring of the electronic document and information of each timestamp applied to each of the divided data items by each server.

Here, the secret sharing scheme is a technique of dividing important data into unimportant data items that don't have a meaning by itself (impossible to restore or infer the important data) described in, for example, A. Shamir, “How to Share a Secret,” Communications of the ACM, vol. 22 no. 11 pp 612-613, 1979. A mechanism using the technique is suggested for reducing a risk of divulging of information by individually storing and transmitting/receiving original data after dividing it into a plurality of data items (unimportant data items).

There are various schemes of secret sharing and there is a scheme called (k, n)-threshold scheme which divides original data in to n-pieces of divided data items. Here, even when the divided data items less than k-pieces (≦n) among the n-pieces of divided data items are collected by a third party, the original data will not be restored based on the data items. In this manner, it is possible to reduce a risk of divulging of information and securely store the original data. On the other hand, when more than k-pieces of divided data items are collected, even less than n-pieces of divided data items make it possible to restore the original data. In this manner, even when less than (n-k)-pieces of divided data items are damaged or lost, the original data can be restored from the remaining more than k-pieces of divided data items, enabling an improvement in availability.

In the present invention, when the original data can be restored from m-pieces (k≦m≦n) of divided data items, the m-pieces of divided data items are considered to be created from the secret sharing scheme from the original data at the same timing and also are not falsified. That is, when the original data cannot be restored from the m-pieces of data items, any of the divided data items are considered to be falsified.

In addition, each of the n-pieces of divided data items are distributed and stored in different servers, and, upon storing them, a timestamp is applied to the divided data item in each server etc. Time information used for the timestamp is, for example, a system time individually set to each server etc. Here, since there are also delay time etc. of the network and processing in respective servers, the timestamps applied to each divided data items which have been collected may be different depending on respective servers, and the timestamp does not always indicate the created/stored time of the original data or a precise standard time at which the divided data item is stored.

However, in each server and data center etc., normally, according to original operation such as periodically synchronizing with other timeservers, countermeasures for correcting the system time of each device in accordance with the standard time at a certain level of accuracy are introduced. Therefore, the timestamp added to each divided data item is considered to also indicate a time close to the standard time at which the divided data is stored at a certain level of accuracy. Therefore, in the present embodiment, based on the timestamp each applied to the m-pieces of data items collected for restoring the original data, a time at which and after which the original data is considered to have at least existed (hereinafter, the time will be sometimes described as “existed time”) is calculated and authentication of created/saved time of the original data is performed.

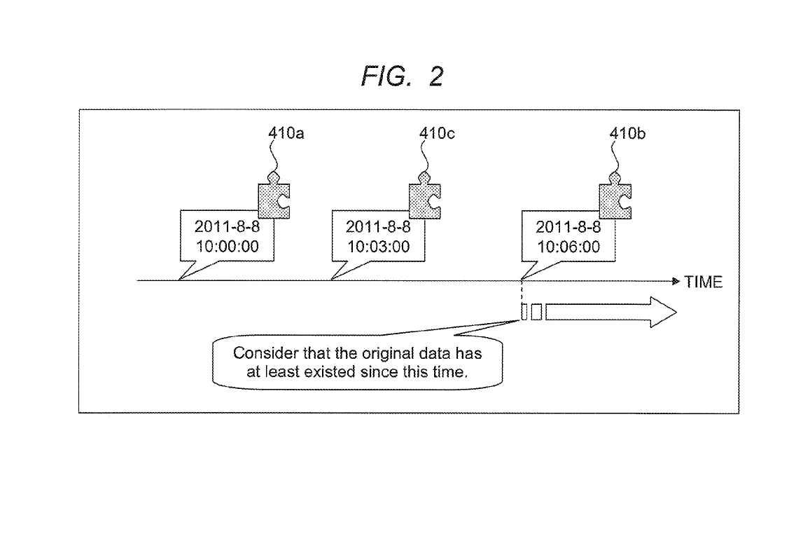

FIG. 2 is a diagram schematically illustrating an example of proving an existed time of original data based on timestamps applied to respective ones of a plurality of divided data items. Here, for example, a state is illustrated in which three divided data items (410a to 410c) stored with a timestamp applied by different servers, respectively, are collected and arranged in time series of the timestamp. In this state, in the present embodiment, it is simply considered such that the original data has been existed as being created and stored and so forth at least on and after the time of the latest timestamp (in the example of FIG. 2, the timestamp applied to the divided data item 410b).

In other words, it is considered such that an event of creating each of the divided data items (processing of creation and saving of the original data in the present embodiment) has been caused to occur at least on and after the time of the latest timestamp among the plurality of divided data items. In this manner, with using the secret sharing scheme, the original data is divided into divided data items and securely stored, and also existed time can be proved simply at a low cost and at a certain level of accuracy.

Here, in each server, bases of authentication are such that: the system time is corrected not always precise but at a certain level of accuracy by an operation; all of the divided data items created by the secret sharing scheme are created at the same timing from an electronic document that is the original data; and, when the electronic document is normally restored from the respective divided data items, falsification etc. to the respective divided data are not made and the restored electronic document is identical to the original.

Note that, to make it more accurate, when a value of k (and n) in the (k, n)-threshold scheme and the number of servers storing n-pieces of divided data items in a distributed manner are increased and the number of samples of timestamps obtained by collecting respective divided data items, it is possible to calculate the existed time at higher accuracy by, for example, a statistic processing of detecting that the value of the latest timestamp is an abnormal value and eliminated that from the sample. On the other hand, when the number of the divided data items is increased, processing load upon the secret sharing processing and distributed storage becomes large, and thus the values of the parameters of k and n are preferable to be set to suitable values in accordance with requirements.

In addition, while the secret sharing scheme creating a plurality of divided data items at the same timing is used in the present embodiment, the scheme is not limited to this. For example, as long as a plurality of data items and files are created when events of execution of a specific processing or events like various application processing such that a plurality of files are created by a specific processing, program in software developing environment such that a plurality of types of files are created upon saving and build of a project, and so forth, by distributing and storing a plurality of files created to a plurality of servers, the existed time at which the event occurred can be proved.

### <System Configuration>

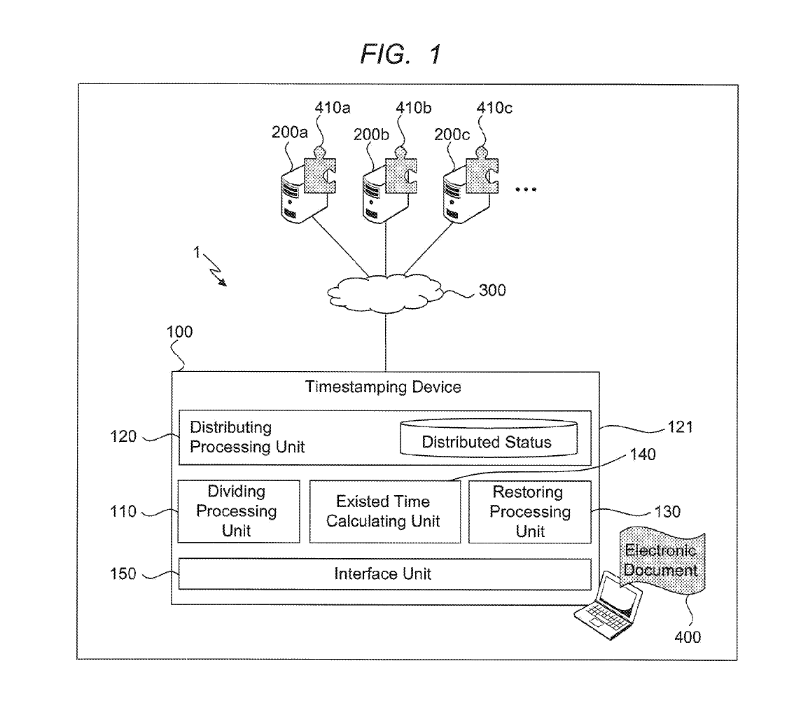

FIG. 1 is a diagram schematically illustrating a configuration example of a timestamping system which is an embodiment of the present invention. A timestamping system 1 has a configuration in which a timestamping device 100 proving an existed time with respect to an electronic document 400 and a plurality of servers 200 (servers 200a to 200c in the example of FIG. 1) are mutually connected via a network 300 such as the Internet.

The timestamping device 100 is, for example, a PC (Personal Computer), a mobile terminal, etc., distributing and storing the electronic document 400 created and stored by a user after dividing the electronic document 400 in to a plurality of divided data items 410 by the secret sharing scheme and store them to respective servers 200 and also performing timestamping with respect to the electronic document 400 in accordance with instructions etc. from the user. The timestamping device 100 includes, for example: a dividing processing unit 110 implemented by software program operated on an OS (Operating System); a distributing processing unit 120; a restoring processing unit 130; an existed time calculating unit 140; an interface unit 150; and etc.

The dividing processing unit 110 divides the electronic document 400, which is an original document about which a user instructs storing into n-pieces of divided data items 410 to be distributed and stored in respective servers 200 via an interface unit 150 described later according to, for example, the (k, n)-threshold secret sharing scheme (k≦n) following a certain procedure. Note that, the algorithm of the secret sharing is not particularly limited and any known scheme can be used.

The distributed processing unit 120 distributes and stores the n-pieces of respective divided data items 410 created from the electronic document 400 by the dividing processing unit 110 after transmitting the n-pieces of divided data items 410 to the respective servers 200 and also records information regarding whether the respective divided data items 410 are stored in any of the servers 200 to a distributed status 121 and manages the information. As to setting information, for example, information such as access information (IP address, host name and etc.) to the respective servers 200 to be distributed storage destinations, and standards or conditions of selecting n-pieces of servers 200 when the existing number of the servers 200 is larger than “n” (for example, a priority order of the servers 200, a list in an order, a method of rotation and etc.) can be previously set in a file, a registry or etc.

Also, upon restoration of the electronic document 400 by a restoring processing unit 130 described later, based on a request from the restoring processing unit 130, following contents of the distribution status 121 and predetermined conditions based on contents of the setting information, the distributing processing unit 120 collects m-pieces of divided data items 410 for restoring the electronic document 400 and passes the same to the restoring processing unit 130.

Note that, the value of the number “m” of the collected divided data items 410 is required to be larger than or equal to “k” which is the number of the divided data items 410 necessary for restoring the electronic document 400, and, all of the n-pieces of the divided data items 410 may be collected (i.e., k≦m≦n). In the setting information not illustrated, according to the value of m, standards and conditions for selecting the m-pieces of servers 200 to be subjects when m<n, and failure etc., a method of deciding which of the servers 200 are substitutional when the divided data items 410 cannot be acquired from the subject servers 200 can be previously set.

Note that, due to failure and so forth of the servers 200, an error response may be given to the user when one or more of the n-pieces of divided data items 410 cannot be stored in respective servers 200 or the number of the divided data items 410 cannot be k or larger upon distributing and storing the divided data items 410. Also, upon transmitting and receiving the divided data items 410 between the servers 200 each other, to further reduce the risk of divulging of information, the timestamping device 100 and each of the servers 200 may transmit and receive the divided data items 410 after applying a predetermined encryption to the divided data items 410.

The restoring processing unit 130 requests to the distributing processing unit 120 and acquires more than or equal to k-pieces of the divided data items 410 necessary for restoring the electronic document 400 about which the user instructs to use for a reference, editing and etc. or timestamping via the interface unit 150. Further, from the acquired k-pieces or more divided data items 410, following a predetermined procedure, the electronic document 400 is restored according to the (k, n)-threshold sharing scheme.

The existed time calculating unit 140 calculates an existed time at which the event of the subject of timestamping has occurred. In the present embodiment, regarding the electronic document 400 restored from the plurality of divided data items 410 by the restoring processing unit 130, based on each of the divided data items 410, a time at which the electronic document 400 is considered to have at least existed (created or stored) in the timestamping device 100 is calculated. Although there are various methods of calculating the existed time, according to the present embodiment, for example, by such the method as described in FIG. 2, the latest time of the timestamps applied to each of the divided data items 410 is calculated and set as the existed timestamp. Here, accuracy may be improved by performing various statistics processing. Also, there may be a margin by having a time period instead of time point.

The interface unit 150 has a user interface like screen display etc. and an input/output function like transmission and reception of data for the timestamping device 100. The user, for example, uses a screen or the like for file management which a general OS has and thus can use the function of the timestamping device 100.

For example, the user moves the electronic document 400 to a specific folder etc. by a simple operation like drag and drop on the screen for file management. Taking it as a trigger, by the divided processing unit 110 and the distributing processing unit 120, the electronic document 400 as an original data is divided into n-pieces of divided data items 410 and each of the divided data items 410 can be securely distributed and stored in each of the servers 200 without making users aware of it. Note that the electronic document 400 may be deleted from the timestamping device 100 and a dummy file or the like corresponding to the electronic document 400 may be created and kept so that the user does not aware of it on the screen for file management.

Also, for example, the user can do operations like reference and edit to the electronic document 400 by performing, on the screen for file management, operations to a dummy file of the electronic document 400 managed in a specific folder. That is, taking operations to the dummy file etc. as a trigger, the distributing processing unit 120 and the restoring processing unit 130 automatically collect m-pieces (k≦m≦n) of the divided data items 410 corresponding to the electronic document 400 from the respective servers 200 and restore the electronic document 400 so that it is available to the user.

Also in the same manner, the user can request timestamping to the electronic document by operations to the dummy file etc. of the electronic document 400. That is, taking a request for timestamping to the dummy file etc. as a trigger, the divided data items 410 are collected from respective servers 200 in the same manner as described above so that the electronic document 400 is restored. Further, by calculating and outputting the existed time based on the respective divided data items 410 by the existed time calculating unit 140, timestamping to the electronic document 400 is made.

Note that, while the timestamping device 100 including an information processing device such as PC or mobile terminal performs division, restoration, distributed storing to respective servers 200 etc. by the secret sharing scheme regarding the electronic document 400 in the example of FIG. 1, these processings may be collectively carried out on a specific server such as a file server for storing the electronic document 400.

The server 200 is an information processing device having a storage device such as an HDD (Hard Disk Drive), not illustrated, capable of storing the divided data item 410 transmitted from the timestamping device 100, being configured by a file server, storage server, etc. Also, a data center having these information processing devices may be used. Moreover, a virtual server or a virtual data center according to cloud computing service may be used.

Each of the servers 200 is assumed to be suitably corrected about the system time by operation. For example, the system time is corrected by periodically synchronizing with a time server etc. Based on the system time, a timestamp is applied upon storing the divided data items 410 to storage devices. This timestamp can be applied by a processing of a normal file system and also separately applied to a header etc. of the divided data item 410.

### <Flow of Processings>

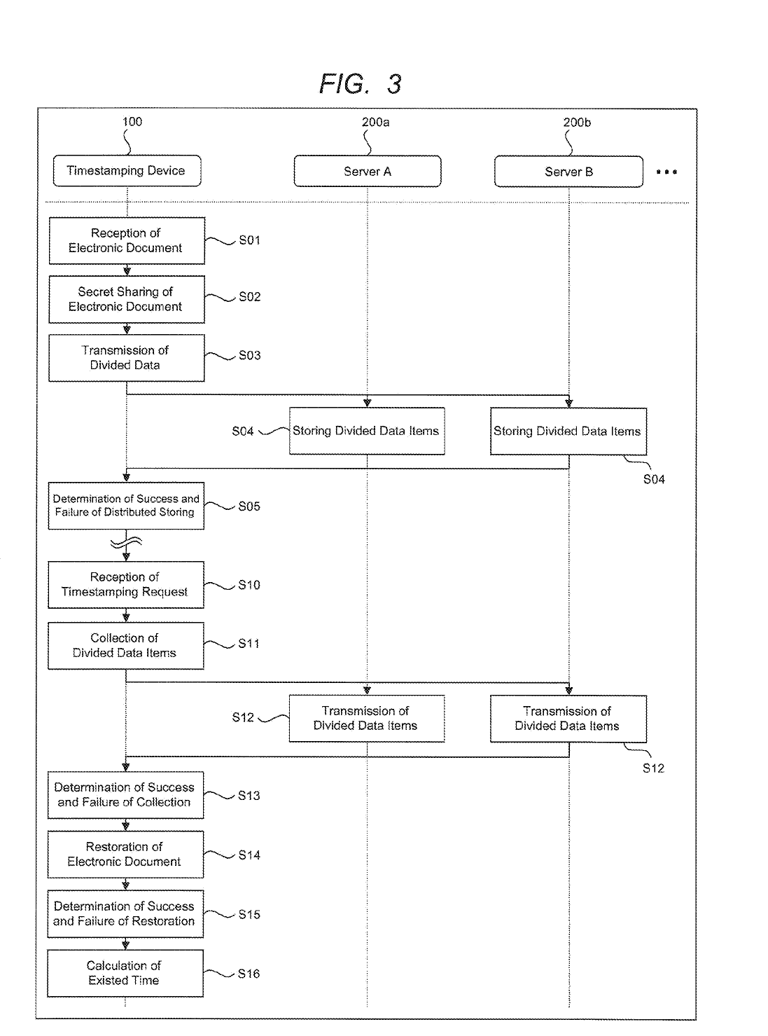

FIG. 3 is a diagram schematically illustrating an example of a processing upon storing the electronic document 400 and performing timestamping to the electronic document 400. In the timestamping device 100, when the electronic document 400 which is a subject to be stored (i.e., subject of timestamping) is received from the user via the interface unit 150 (S01), the dividing processing unit 110 divides the electronic document 400 into a plurality of data items 410 by the secret sharing scheme (S02). For example, according to the (k, n)-threshold secret sharing scheme, division into n-pieces of divided data items 410 is done.

Next, by the distributing processing unit 120, the n-pieces of divided data items 410 are transmitted to n-pieces of different servers 200 determined based on a predetermined rule, respectively (S03). In FIG. 3, an example of transmitting the divided data items 410 to a server A (200a) and a server B (200b), respectively. Each of the servers 200 which has received the divided data item 410 stores the divided data item 410 in a storage device after applying a timestamp based on the system time to it (S04) and responding to the timestamping device 100 with a processing result.

The timestamping device 100 determines whether all the n-pieces of divided data items 410 are normally stored in the servers 200 by the distributing processing unit 120 (S05). Here, when even one of the n-pieces of divided data items 410 cannot be normally stored, an error notification may be given to the user via the interface unit 150. At this time, the sequence of processing may be subjected to rollback. In addition, even when there is the divided data item 410 not normally stored, when storage of k or more number of the divided data items 410 is normally finished, it may not be regarded as an error since the electronic book 400 is restorable.

When the distributed storage to the respective servers 200 is normally finished, a dummy file corresponding to the electronic document 400 may be created. Also, the electronic document 400 and the divided data items 410 created by the dividing processing unit 110 may be deleted from the storage device of the timestamping device 100.

Thereafter, when request for timestamping to the electronic document 400 (or a request for referencing etc. of the electronic document 400) is received from the user by operations etc. to the dummy file via the interface unit 150 (S10), the restoring processing unit 130 requests for acquisition of m-pieces (m≧k) of the divided data items 410 to the distributing processing unit 120 for restoring the specified electronic document 400. The distributing processing unit 120 specifies the servers 200 which are storing the divided data items 410 created from the subject electronic document 400 based on the distributed status 121 and setting information etc. not illustrated and so forth, and collects these divided data items 410 from the respective servers 200 (S11). Each of the servers 200 requested for acquisition of the divided data items 410 transmits the corresponding divided data item 410 from the storage device to the timestamping device 100.

The timestamping device 100 determines whether the number m′ of the divided data items 410 which are successfully normally collected is larger than k or not, k being a number required for restoring the electronic document 400 (S13). Here, when k or more number of the divided data items 410 cannot be collected, an error notification may be given to the user via the interface unit 150.

When k or more number of the divided data items 410 can be collected, the electronic document 400 is restored by the (k, n)-threshold secret sharing scheme from the collected m′-pieces of divided data items 410 by the restoring processing portion 130 (S14). Here, whether the electronic document 400 is normally restored or not is determined (S15). When a part of the divided data items 410 is, for example, falsified, the original data cannot be normally restored by the secret sharing scheme and thus achieving normal restoration can prove that the divided data items 410 are not falsified and thus the electronic document 400 is identical to the original.

When the electronic document 400 is normally restored, the existed time calculating unit 140 calculates an existed time of the electronic document 160 (S16). Here, as described above, the latest time among the timestamps applied to the respective divided data items 410 used for restoring the electronic document 400, and it is considered that the electronic document 400 has existed at least at the time and thereafter, regarding this time as the existed time. A value of the existed time may be, for example, outputted to the user via the interface unit 150, and may be applied to the electronic document 400 as an authenticated timestamp.

As described in the foregoing, according to the timestamping system 1 which is the embodiment of the present invention, the electronic document 400 is divided into a plurality of divided data items 410 by the secret sharing scheme and they are stored in mutually different servers 200. The divided data items 410 being distributed and stored in respective servers 200 are collected, and, when the electronic document 400 can be normally restored based on them, the latest time among the timestamps applied in the servers 200 is taken as the existed time of the electronic document 400. In this manner, as well as the electronic document 400 is securely stored after being divided into divided data items 410 which are meaningless unimportant data by themselves, proof of the existed time of the electronic document 400 can be performed at a low cost and in a simple way.

Moreover, not only the situation as described in the present embodiment of authenticating the time of creation and storage of the electronic document 400 by timestamps of the plurality of divided data items 410 created by the secret sharing scheme, but also an existed time at which execution of a specific processing such that a plurality of data items or files are created at the same timing and occurrence of matters like an event etc. occur is also able to be proven based on timestamps applied to a plurality of files created and distributed and stored in the plurality of servers 200.

In the foregoing, the invention has been concretely described based on the embodiments. However, it is needless to say that the present invention is not limited to the foregoing embodiments and various modifications and alterations can be made within the scope of the present invention.

The present invention can be used to a timestamping system and a timestamping program which authenticates time or time period at which a file or data is created and saved.

1-5. (canceled)

6. A timestamping system comprising: a plurality of servers including a storage device; and a timestamping device being connected to each of the servers via a network and authenticating an existed time at which an event such that a plurality of data items are created at the same timing is considered to have at least occurred,
wherein the timestamping device includes:
a distributing processing unit transmitting the plurality of data items created at the same timing upon the event to the servers being different from each other, respectively, and collecting the data items corresponding to the event requested for timestamping from a user from each of the servers, respectively; and
an existed time calculating unit calculating and outputting the existed time regarding the event based on the timestamps applied to each of the data items collected from each of the servers, and
the server applies the timestamps to the data items transmitted from the timestamping system and stores the same in the storage device.

7. A timestamping system comprising: a plurality of servers having a storage device; and a timestamping device being connected to each of the servers via a network and authenticating an existed time at which an electronic document is considered to have at least created and existed,
the timestamping device includes:
a dividing processing unit dividing the electronic document into a plurality of divided data items by a secret sharing scheme;
a distributing processing unit transmitting each of the divided data items to the servers being different from each other, and collecting each of the divided data items corresponding to the electronic document requested for timestamping from a user;
a restoring processing unit restoring the electronic document by a secret sharing scheme based on each of the divided data items collected from each of the servers when the electronic document can be normally restored; and
an existed time calculating unit calculating the existed time regarding the electronic document based on timestamps applied to the divided data items collected from the servers when the electronic document can be normally restored by the restoring processing unit, and
the server applies a timestamp to the divided data transmitted from the timestamping system and stores the same in the storage device.

8. The timestamping system according to claim 6,
wherein the existed time calculating unit of the timestamping device considers the latest time among the timestamps applied to the data or the divided data items collected from the servers as the existed time.

9. The timestamping system according to claim 6,
wherein the existed time calculating unit of the timestamping device calculates the existed time by performing a predetermined statistic processing regarding the timestamps applied to the data items or the divided data items collected from each of the servers.

10. A timestamping program letting a computer function as a timestamping device in a timestamping system that includes: a plurality of servers having a storage device; and the timestamping device being connected to the servers via a network and authenticating an existed time at which an electronic document is considered to have at least created and existed,
the timestamping program executing:
a dividing processing of dividing the electronic document into a plurality of divided data by a secret sharing scheme;
a distributing processing of transmitting the divided data items to the servers being different from each other to store the same and collecting each of the divided data items corresponding to the electronic document being requested for timestamping from a user from each of the servers;
a restoring processing of restoring the electronic document by the secret sharing scheme based on each of the divided data items collected from each of the servers; and
an existed time calculating processing of calculating and outputting the existed time regarding the electronic document based on timestamps applied by the servers to each of the divided data items collected from each of the servers when the electronic document can be normally restored in the restoring processing.

11. The timestamping system according to claim 7,
wherein the existed time calculating unit of the timestamping device considers the latest time among the timestamps applied to the data or the divided data items collected from the servers as the existed time.

12. The timestamping system according to claim 7,
wherein the existed time calculating unit of the timestamping device calculates the existed time by performing a predetermined statistic processing regarding the timestamps applied to the data items or the divided data items collected from each of the servers.

13. The timestamping system according to claim 8,
wherein the existed time calculating unit of the timestamping device calculates the existed time by performing a predetermined statistic processing regarding the timestamps applied to the data items or the divided data items collected from each of the servers.
